(19) United States
(12) Patent Application Publication
(10) Pub. No.: US 2026/0131305 A1
(43) Pub. Date: May 14, 2026

(54) MANUFACTURE OF BASALT FIBER SORBENT BOOM

(71) Applicant: Valerie Ann Gamble, Houston, TX (US)

(72) Inventor: Valerie Ann Gamble, Houston, TX (US)

(21) Appl. No.: 19/089,539

(22) Filed: Mar. 25, 2025

Related U.S. Application Data
(60) Provisional application No. 63/720,130, filed on Nov. 13, 2024.

(51) Int. Cl. B01J 20/16; B01J 20/28; B01J 20/30; C02F 1/28

(52) U.S. Cl. CPC B01J 20/165; B01J 20/28038; B01J 20/28042; B01J 20/3085; C02F 1/281

(57) ABSTRACT

A method of manufacture includes forming a sorbent layer surrounding a core structure having a prismatic shape. In the method of manufacture, the sorbent layer comprises basalt fiber, while a first length of the sorbent layer corresponds to a second length of the core structure.

### BACKGROUND

### Field Of The Disclosure

The present disclosure relates generally to water remediation and, more particularly, to a basalt fiber sorbent boom for removal of undesirable materials.

### BACKGROUND

Undesirable materials in surface water, such as toxic materials or other foreign chemicals, inadvertently released into surface water, such as fresh water or sea water bodies, can pose a significant environmental hazard to surrounding areas and ground water. Typically, costs and resources involved with remediating such undesirable materials from the surface water, such as by decontaminating or detoxifying the surface water, may be prohibitively expensive. In particular, methods and devices that collect and transport the surface water to a different location for remediation may involve an economically prohibitive amount of resources.

Certain conventional solutions to remove the undesirable materials may involve placing typical sorbent booms in contaminated surface water to capture the undesirable materials that generally float on top of the surface water. Typical sorbent booms are often designed to float on contaminated surface water and capture the undesirable materials, such that at least some undesirable material can be removed by physically retrieving and extracting the typical sorbent boom after some immersion time in the surface water.

### SUMMARY

In one aspect, a first sorbent boom is disclosed. The first sorbent boom may include a core structure having a first length, and a sorbent layer surrounding the core structure substantially over the first length. In the first sorbent boom, the sorbent layer may include basalt fiber.

In any of the disclosed embodiments of the first sorbent boom, the sorbent layer may consist of basalt fiber.

In any of the disclosed embodiments, the first sorbent boom may include a retention mesh surrounding the sorbent layer. In the first sorbent boom, the retention mesh may include basalt.

In any of the disclosed embodiments of the first sorbent boom, the core structure may have a first shape in cross-section and the sorbent layer may have a second shape in cross-section, while the sorbent layer may fill at least the second shape over the first length.

In any of the disclosed embodiments of the first sorbent boom, the first shape may be substantially circular having a first diameter, and the second shape may be substantially ring-shaped having a second diameter corresponding to an inner portion of the second shape and a third diameter corresponding to an outer portion of the second shape. In the first sorbent boom, the first diameter may correspond to the second diameter. In any of the disclosed embodiments of the first sorbent boom, the third diameter may be substantially constant over the first length.

In any of the disclosed embodiments of the first sorbent boom, the first diameter may be reduced at a first portion at a sub-length along the first length, while the sub-length may have a second length shorter than the first length. In the first sorbent boom, the first portion may result in increased flexibility of the sorbent boom at the first portion.

In any of the disclosed embodiments of the first sorbent boom, the first shape may correspond to a first polygon. In the first sorbent boom, the first polygon may be substantially similar to the second shape, the first polygon may be different from the second shape, or the first polygon may correspond to the second shape.

In any of the disclosed embodiments of the first sorbent boom, the core structure may include a buoyant material. In the first sorbent boom, the buoyant material may provide sufficient buoyancy to float the sorbent boom in at least one of fresh water or sea water.

In any of the disclosed embodiments of the first sorbent boom, the buoyant material may include at least one of a porous material or a particulate material.

In any of the disclosed embodiments of the first sorbent boom, the buoyant material may be selected from at least one of: a ceramic material, a natural material, an organic material, or a metallic material. In the first sorbent boom, the buoyant material may include pumice or scoria.

In any of the disclosed embodiments of the first sorbent boom, the core structure may include a tube along the first length. In the first sorbent boom, the tube may be filled with a particulate material. In the first sorbent boom, the particulate material may include a buoyant material. In any of the disclosed embodiments of the first sorbent boom, the tube may be segmented along the first length to provide increased flexibility to the sorbent boom.

In another aspect, a second sorbent boom is disclosed. The second sorbent boom may include a core structure having a first length and may include a buoyant material. The second sorbent boom may include a sorbent layer surrounding the core structure substantially over the first length. In the second sorbent boom, the sorbent layer may include basalt fiber. The second sorbent boom may include a mesh structure surrounding the core structure. In the second sorbent boom, the sorbent layer may be substantially cylindrical in shape, while the buoyant material may provide sufficient buoyancy to float the sorbent boom in at least one of fresh water or sea water.

In yet another aspect, a third sorbent boom is disclosed. The third sorbent boom may include a core structure having a first length and being externally porous to water, and a sorbent layer surrounding the core structure substantially over the first length. In the third sorbent boom, the sorbent layer may include basalt fiber that is porous to water.

In still another aspect, a first method of manufacture is disclosed. The first method may include forming a sorbent layer surrounding a core structure having a prismatic shape to produce a sorbent boom. In the first method, the sorbent layer may include basalt fiber, while a first length of the sorbent layer may correspond to a second length of the core structure.

In any of the disclosed embodiments of the first method, the sorbent layer may consist of basalt fiber.

In any of the disclosed embodiments of the first method, the prismatic shape may be selected from at least one of: a cylinder, a polygonal prism, or an irregular prism.

In any of the disclosed embodiments of the first method, the core structure may be a solid structure.

In any of the disclosed embodiments of the first method, forming the sorbent layer may further include wrapping the sorbent layer around the core structure. In the first method, the sorbent layer may have a first width selected from at least one of: a roving, a wound yarn, a mat, or a felt.

In any of the disclosed embodiments of the first method, the core structure may be provided as a continuous material, while wrapping the sorbent layer around the core structure may further include continuously winding the sorbent layer around the core structure. In the second method, continuously winding the sorbent layer around the core structure may further include continuously winding the sorbent layer at an angle of winding.

In any of the disclosed embodiments, the first method may include, forming a mesh layer surrounding the sorbent layer.

In any of the disclosed embodiments, the first method may include forming the core structure as a continuous structure.

In any of the disclosed embodiments, the first method may include, forming the core structure as a segmented structure that provides flexibility to the sorbent boom along the length.

In any of the disclosed embodiments of the first method, forming the core structure as the segmented structure may further include reducing a cross-sectional area of the core structure.

In any of the disclosed embodiments of the first method, forming the sorbent layer may further include selecting the sorbent layer based on a volume density of the basalt fiber in the sorbent layer corresponding to an absorption capacity of the sorbent boom for undesirable material.

In any of the disclosed embodiments of the first method, the absorption capacity of the sorbent boom for the undesirable material may be determined at least in part based on a viscosity of the undesirable material at ambient temperature.

In any of the disclosed embodiments of the first method, forming the sorbent layer may further include forming the sorbent layer by forming multiple sorbent sub-layers comprising basalt fiber.

In any of the disclosed embodiments, the first method may include subjecting the sorbent boom to a treatment selected from at least one of a heat treatment or a chemical treatment. In any of the disclosed embodiments of the first method, subjecting the sorbent boom to the heat treatment may further include subjecting the sorbent boom to the heat treatment in an underpressure environment. In the first method, subjecting the sorbent boom to the chemical treatment may further include subjecting the sorbent boom to an acid or a base.

In any of the disclosed embodiments, the first method may include, subsequent to subjecting the sorbent boom to the treatment, hermetically sealing the sorbent boom.

In still a further aspect, a second method of manufacture is disclosed. The second method may include forming a sorbent layer around a core structure to produce a sorbent boom. In the second method, the sorbent layer may include basalt fiber. The second method may include subjecting the sorbent boom to a treatment selected from at least one of a heat treatment or a chemical treatment.

In any of the disclosed embodiments, the second method may include hermetically sealing the sorbent boom.

In still a further aspect, a third method of manufacture is disclosed. The third method may include forming a sorbent layer around a core structure to produce a sorbent boom. In the third method, the sorbent layer may include basalt fiber. The third method may include subjecting the sorbent boom to a treatment selected from at least one of a heat treatment or a chemical treatment, and hermetically sealing the sorbent boom. In the third method, a volume density of the basalt fiber may be determined based on an absorption capacity of the basalt fiber for undesirable material. In the third method, the absorption capacity may be determined at least in part based on a viscosity of the undesirable material at ambient temperature.

### BRIEF DESCRIPTION OF THE DRAWINGS

For a more complete understanding of the present disclosure and its features and advantages, reference is now made to the following description, taken in conjunction with the accompanying drawings.

FIG. 1 is a depiction of a basalt fiber sorbent boom, in one exemplary embodiment.

FIGS. 2A, 2B, and 2C are respective depictions of a basalt fiber sorbent boom with an outer mesh layer, in three exemplary embodiments.

FIG. 3A is a depiction of a basalt fiber sorbent boom with orthogonal orientation, in one exemplary embodiment.

FIG. 3B is a depiction of a basalt fiber sorbent boom with angled orientation, in one exemplary embodiment.

FIG. 4A shows depictions of a triangular boom shape, in two exemplary embodiments.

FIG. 4B shows depictions of a square boom shape, in two exemplary embodiments.

FIG. 4C shows depictions of a hexagonal boom shape, in two exemplary embodiments.

FIG. 5A is a depiction of a segmented boom, in one exemplary embodiment.

FIG. 5B is a depiction of a segmented boom, in one exemplary embodiment.

FIG. 5C is a depiction of a segmented boom, in one exemplary embodiment.

FIG. 6 is a flow chart of a method of forming a basalt fiber sorbent boom, in one exemplary embodiment.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the unhyphenated form of the reference numeral refers to the element generically or collectively. Thus, as an example (not shown in the drawings), device “12-1” refers to an instance of a device class, which may be referred to collectively as devices “12” and any one of which may be referred to generically as a device “12”. In the figures and the description, like numerals are intended to represent like elements.

The presence of certain undesirable materials in the environment remains an ongoing problem. For example, certain spills of undesirable materials on land or on surface water can contaminate the environment in an unexpected manner, such as by inadvertent or accidental events. A diversity of spill types and scenarios may be involved with various remediation methods and solutions to mitigate adverse impacts on the environment.

On land, spills of undesirable materials can occur due to transportation failures such as tanker truck collisions, train derailments, pipeline ruptures, or can also occur due to leaks, overflows, or structural failures of storage facilities of the undesirable materials. Spills on land may contaminate the soil and surrounding environments, and may cause adverse effects to the ground environment, including potentially contaminating ground water.

On surface water, such as ponds, streams, rivers, lakes, seas, or oceans, for example, spills of undesirable materials can occur due to certain transportation failures such as maritime accidents, equipment failures, or even from military actions or terrorism, that can result in damage to maritime vessels or sinking of maritime vessels. In some cases, a combination of land and surface water contamination may result, such as from spills near a coastline or runoff into surface water from spills occurring on land, among other causes.

Undesirable materials subject to such undesirable spillage into the environment may include a broad range of natural and synthetic chemical contaminants. As used herein, undesirable materials may include alcohols, volatile organic compounds, plasticizers, toxic materials, pollutants, disruptors, biohazards, aliphatic hydrocarbons, aromatic hydrocarbons, crude oil along with constituent materials, diesel fuel, gasoline, aromatic hydrocarbons (including benzenes, toluenes, xylenes and polyaromatic hydrocarbons or hydroaromatic hydrocarbons), aliphatic hydrocarbons, olefins, dispersants, emulsifiers, stabilizers, corrosion inhibitors, biocides, colorants or dyes, dioxins, furans, halogenated biphenyls, polychlorinated biphenyls (PCBs, Aroclor-1016, Aroclor-1260), bis(2-ethylhexyl)phthalate, arsenic, mercury, chromium, copper, nickel, zinc, cadmium, lead, or materials containing other metals, such as heavy metals or toxic metals or various combinations thereof. Furthermore, undesirable materials can include hydrocarbons such as paraffins, naphthene, aromatic molecules, methane, or various combinations thereof. In particular embodiments, certain plastics or polymers may also be included in the undesirable materials. For example, microplastic particles, generally defined as ranging from 1 micron to 5 mm in diameter or size, that can be comprised of various polymer compositions may also be included among the undesirable materials disclosed and described herein.

As noted, hydrocarbons may include, but are not limited to, aliphatic hydrocarbons and aromatic hydrocarbons, including but not limited to, olefins, polyaromatic hydrocarbons, hydroaromatic hydrocarbons, halogenated hydrocarbons, or derivatives thereof. Aromatic hydrocarbons may include, but are not limited to, benzenes, toluenes, xylenes, dioxins, furans, polychlorinated biphenyls (PCBs), or bisphenol A (BPA). Metals may include but are not limited to, heavy metals, toxic metals, metal alloys, or combinations thereof, such as arsenic, mercury, chromium, copper, nickel, zinc, cadmium, or lead. Plasticizers may include, but are not limited to, phthalate esters, adipates, sebacates, or benzoates. In particular cases, common undesirable materials subject to spills on surface water or on land include crude oil and various refined fractions obtained from crude oil, such as gasoline, kerosine, or diesel that are widely used and transported as fuels.

As noted, various spills or releases of undesirable materials on surface water or on land have been removed using typical sorbent booms or similar devices and products. Typical sorbent booms used for remediating spills of undesirable materials and removing the undesirable materials, at least in part, may include a filler material comprising various petroleum-derived polymers, such as polypropylene, polyethylene, expanded polystyrene, polyester, among others.

As indicated, typical sorbent booms can be undesirable remediation tools on surface water due to various issues. For example, typical sorbent booms may capture a significant amount of surface water while also capturing some of the undesirable materials for spills on surface water. By capturing both the surface water and the undesirable materials, typical sorbent booms may not provide good mass efficiency at capturing the undesirable materials, since typical methods involve removing and transporting the typical sorbent boom after exposure or immersion in the undesirable material. As a result of the poor mass efficiency, the overall resources involved (e.g., material, equipment, labor, logistics, etc.) with remediating spills using typical sorbent booms may be increased for a given mass or volume of the undesirable material removed, which is disadvantageous.

Additionally, typical sorbent booms may utilize polymer materials for packaging and buoyancy in the water during the remediation process. The ongoing introduction of polymer material into surface water has itself been recognized as a potential contamination source that is expected to be subject to regulatory restrictions in the future, including prohibition of use in surface water, among other places in the environment in general.

Furthermore, typical sorbent booms may function poorly when used in the absence of water, such as for remediation of undesirable materials on dry land. In particular, typical sorbent booms may lack the ability to capture lighter aliphatic fractions, such as lighter oils, oil and gasoline mixtures, or, in particular, diesel fuel, whether in surface water or on land.

For example, a typical sorbent boom may comprise petroleum-derived materials, containing polypropylene as a filler material, such as having a polypropylene skin and a polyester mesh. Other kinds of conventional sorbent booms may include filler materials such as cellulose, vermiculite, or other filler materials that are generally hydrophilic and can absorb a significant amount of water, which reduces their mass efficiency, which, as explained above, is undesirable.

Furthermore, typical sorbent booms may be inefficient or unsuitable for capturing certain undesirable materials. For example, the removal of spills of hydrocarbon fuels having lower viscosity and lower density, such as diesel fuel or other light oils or light fuels refined from crude oil may be difficult or impossible using typical sorbent booms.

Additionally, concerns regarding the widespread release of petroleum-derived products into the environment, such as various polymers and plastics, have increased in recent years. Single-use plastics have been the subject of regulation in various jurisdictions, and the regulation and prohibition of petroleum-derived polymer components for general use or release into the environment is expected to increase in the future.

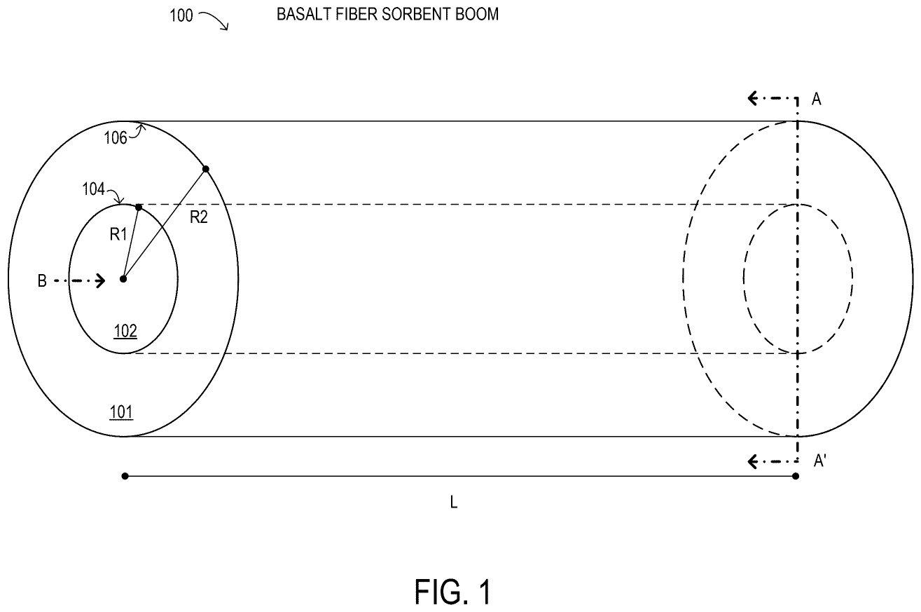

In contrast to the use of petroleum-derived polymers in typical sorbent booms, basalt is a natural mineral that can be reshaped into various different form factors. The form factors of basalt or basalt fiber used in the basalt fiber sorbent boom disclosed herein may include continuous fiber, chopped fibers, roving, filaments, mats, felt, strands, chopped strands, particles, pellets, textiles, fabrics, tape, yarn, mesh, wool, or combinations thereof. The form factors of basalt or basalt fiber used may further be formed into a sorbent layer whose properties can be tailored to specific applications of remediating undesirable materials. Specifically, a density of the sorbent layer (see basalt fiber layer 101 in FIG. 1) can be selected for a desired porosity to water, such as when used in surface water. The density of the sorbent layer can also be selected based on a viscosity of a particular undesirable material to be absorbed or adsorbed, such as diesel fuel in one example, when used on land or on surface water. In particular embodiments, viscosity values can be specified at a standard temperature or at an ambient temperature.

For example, U.S. Pat. No. 12,037,264 issued on Jul. 16, 2024 (hereinafter referred to as the “'264 patent”) describes experiments using a needlepunch mat comprising basalt fibers to capture toxic materials from wastewater by immersing the needlepunch mat in a wastewater body. It is believed that the adsorption of the undesirable materials described in the '264 patent results from the surface affinity of the basalt fibers to the toxic materials and is promoted by the hydrophobic nature of the basalt fibers. Furthermore, a form factor of the basalt fibers used in the needlepunch mat, as well as the presence of certain irregularities on the surface of the basalt fibers, both increase the effective surface area of the basalt fibers that is available for adsorption of the toxic materials. The toxic materials recited in the '264 patent, which is hereby incorporated by reference in its entirety, are included among the undesirable materials disclosed herein, as noted above.

As a result of the hydrophobic properties of basalt, including of basalt fiber, the basalt fiber sorbent boom disclosed herein may essentially remain unwetted under exposure to water, and therefore, may retain insignificant amounts of water when partially or fully immersed in water. Furthermore, experiments and industry-standard testing have established that basalt fiber exhibits a strong selective affinity for various undesirable materials in the presence of water, including hydrocarbon fractions such as diesel fuel and other lighter oils. In particular, basalt fiber has been demonstrated to exhibit substantially improved mass efficiency at selectively absorbing and retaining various undesirable materials, and in particular such lighter hydrocarbon fractions, such as when subjected to an oil water mixture (e.g., using diesel fuel in one example) that is characteristic for spills of such undesirable materials on surface water. Because of the general affinity of basalt fiber to various hydrocarbons such as found in crude oil, including lighter hydrocarbon fractions, basalt fiber is also highly suitable for remediation of undesirable materials from dry land, such as in the absence of water. As a result of the foregoing, it has been found that basalt fiber can be used advantageously for remediation of spills of undesirable materials, even for the lighter hydrocarbon fractions, such as diesel fuel and lighter oils, in contrast with typical sorbent booms that are often ineffective or inoperable in such applications for capturing the lighter hydrocarbon fractions.

As disclosed herein, a basalt fiber sorbent boom can be used for remediation of spills of undesirable materials on surface water or on land or both. Also disclosed herein are methods of use and methods of manufacturing the basalt fiber sorbent boom. In particular, the ability to capture spilled undesirable materials in situ, such as by using the basalt fiber sorbent boom disclosed herein, may offer significant advantages. In various use cases, the basalt fiber sorbent boom can be deployed in different contexts and may be used in a substantially similar manner as typical sorbent booms, such as on surface water or on land, that allows for widespread use with existing infrastructure, personnel, equipment, logistics, or other conventional resources, which is desirable.

In various embodiments, the basalt fiber boom may be comprised of at least one basalt fiber layer. The basalt fiber layer of the basalt fiber sorbent boom may be formed from various form factors, sizes, or shapes of the basalt fiber. In particular implementations, the type of basalt fibers used in the basalt fiber layer can be selected based on specific undesirable materials or physical properties of the undesirable materials, such as a viscosity or a chemical affinity of the undesirable materials. For example, a denser or less porous basalt fiber layer may be used to capture and retain lighter, less viscous hydrocarbons, such as diesel, kerosene, light fuel oils, or other plant-based oils, while a less dense or more porous basalt fiber layer may be used for capturing more viscous hydrocarbons, such as certain crude oils, heavy oils, tar, or heavy fuel oils (HFO), in particular examples. Such heavy oils or heavy fractions may include creosote and constituent compounds in some cases, among other undesirable materials as disclosed herein. Similarly, a number of the layers of the basalt fiber, an overall size or diameter of the basalt fiber sorbent boom, or a overall amount of the basalt fiber per linear unit of the basalt fiber sorbent boom can be selected for various applications and desired quantities of the undesirable materials to be captured.

The basalt fiber sorbent boom having the basalt fiber layer may capture and retain the undesirable materials as a result of physical processes or chemical processes, or a combination thereof. Accordingly, the retention mechanisms of the undesirable material to the basalt fiber in the basalt fiber sorbent boom man include physical processes, chemical processes, covalent bonding, ionic bonding, surface tension, van der Waals forces, or capillary action, among other mechanisms. The basalt fiber sorbent boom may selectively capture and retain certain hydrocarbons, such oily fractions, including heavy fractions such as crude oil and lighter fractions such as diesel fuel or lighter oils, in the presence of surface water, or on land in the absence of water. Because the basalt fiber sorbent boom disclosed herein may generally be hydrophobic, the basalt fiber sorbent boom may exhibit an improved mass efficiency for selectively capturing undesirable materials when used in the presence of surface water, as compared to typical sorbent booms. In cases where the undesirable materials comprise particulate matter, such as microplastic particles, among others, the basalt fiber sorbent boom disclosed herein may capture and retain the particular matter using various retention mechanisms, as noted above, that may be effective to varying degrees.

The basalt fiber sorbent boom disclosed herein may comprise a core structure and a basalt fiber layer. The basalt fiber layer may surround or enclose the core structure. In some embodiments, the core structure may be omitted. Additionally, in some embodiments, an outer mesh layer (also referred to as “a retention mesh”) may surround or enclose the basalt fiber layer. For example, the outer mesh layer may retain or secure the basalt fiber layer, or may provide improved protection against external forces that may loosen or separate at least some of the basalt fiber layer.

In various embodiments, the basalt fiber sorbent boom, as disclosed herein, may be provided as a commercial product in a similar manner as typical sorbent booms. For example, the basalt fiber sorbent boom can be manufactured and then packaged for sale as a commercial product. To enable a longer shelf life with effective performance for use after manufacture and storage, the basalt fiber sorbent boom may be packaged using a hermetically sealed packaging to protect the basalt fiber layer from the environment until the point of use.

In another example, the basalt fibers may be chemically treated prior to packaging. For example, during manufacture of some types of basalt fibers, such as mats, felts or other types of woven or non-woven material using techniques such as needlepunching, knitting, sewing, or others, the basalt fibers may be treated with a so-called “sizing” or coating material. The coating material may improve suitability of the basalt fiber for a given processing technique. Accordingly, a coating material, such as silane or siloxane, among others, may be present on exterior surfaces of the basalt fiber when the sorbent boom is manufactured.

To improve the ability of the basalt fiber layer to capture or retain the undesirable materials after manufacture, the basalt fiber layer may be treated prior to packaging under hermetic sealing. For example, heat treatment of the basalt fibers may include heating the basalt fibers to a temperature between 200 and 900 degrees Celsius, or a higher temperature, to improve the adsorption or absorption performance of the surface of the basalt fibers. The heat treatment of the basalt fibers may be performed under normal atmospheric conditions, or may be performed in a controlled environment, such as in an underpressure environment, in a vacuum, or under exposure to a predetermined gas, such as nitrogen or other gas mixtures. For example, the basalt fibers may be heat-treated at the desired temperature for a period between 15 minutes and 3 hours, among other durations. In one example of the heat treatment, the basalt fibers are heated to about 400 degrees Celsius for about 45 minutes. The heat treatment may occur before, during, or after the basalt fiber layer is manufactured, or combinations thereof in various embodiments.

In another example of treating the basalt fibers prior to packaging, a chemical treatment might be applied to the basalt fibers to improve the adsorption or absorption performance of the surface of the basalt fibers. The chemical treatment might involve exposure of the basalt fibers to an acid or to a base, for example. In particular embodiments, an acid treatment may be suitable for the basalt fibers to retain or adsorb certain types of undesirable materials, such as certain toxic aromatic hydrocarbons. For the basalt fibers to retain or adsorb other types of undesirable materials, such as lighter oil fractions, including diesel fuel, the heat treatment noted above may suffice without further chemical treatment. In particular embodiments, the heat treatment may be used together with the chemical treatment, such as after the chemical treatment. Accordingly, the treatment of the basalt fibers in the sorbent boom may be selected based on a particular undesirable material that the sorbent boom is intended to retain, adsorb, or absorb.

Various types of hermetically sealed packaging may be used, such as films or bags made of various materials. Because the packaging can be prevented from release into the environment when the basalt fiber sorbent boom is used, the packaging may be based on polymers or plastics in some embodiments. In certain cases, bulk packaging of multiple basalt sorbent booms can be hermetically sealed, such as with a container that can be reusable or can be recycled, for example.

In some embodiments, such as for use on surface water, the core structure may comprise a buoyant material having a relatively low density that allows the basalt fiber sorbent boom to float, at least to a degree of buoyancy. In particular implementations, the core structure may be constructed using a buoyant material such as a ceramic foam. Ceramic foams are materials that have a low density and can be highly porous materials that provide sufficient buoyancy to the basalt fiber sorbent boom. Ceramic foams can be used without or as a replacement for petroleum-derived polymer materials used in some typical sorbent booms that are undesirable, as explained above. In various embodiments, the core structure may comprise natural ceramic foams, artificial ceramic foams, combined natural and engineered ceramic foams, pumice, scoria, tuff, alumina, zirconia, cordierite, expanded perlite, silicon carbide, and expanded clay aggregate (ECA). The amount of material used in the core structure may be selected to allow the basalt fiber sorbent boom to float on surface water having different salinity levels, including after the basalt fiber sorbent boom is saturated with an amount of the undesirable material that increases an overall weight of the basalt fiber sorbent boom with the undesirable material.

In particular embodiments, the basalt fiber layer or layers may be directly wrapped around the core structure, such when the core structure comprises a particulate of a given size that can vary from fine grained, coarse grained, gravel, or rock-sized particles, among others. In some embodiments, a hollow tube or a hollow prism may be used for the core structure that can be sealed to provide buoyancy. The hollow tube or the hollow prism can also be filled with the buoyant material as described above, such that the hollow tube or the hollow prism can be solid or can be perforated, among other combinations and implementations. Thus, when the hollow tube is omitted or is perforated, the core structure can be porous to water, such as when the basalt fiber sorbent boom is used in surface water.

In the basalt fiber sorbent boom disclosed herein, the basalt fiber layer may be wrapped or placed around the core structure without securing to the core structure, in some embodiments. In various embodiments, the basalt fiber layer may be secured to the core structure using various types of fixtures or fasteners, such as those made from metal wiring, or may be affixed to the core structure by an adhesive. The basalt fiber sorbent boom may incorporate optional layers in some embodiments, such as a backing web or another stiffening or strengthening layer that may be bonded to the basalt fiber layer on one or more sides. In some embodiments, the optional layers may be porous and chemically inert, and may provide mechanical strength and durability.

In some embodiments of the basalt fiber sorbent boom disclosed herein, the core structure may be omitted, such that the basalt fiber sorbent boom comprises the basalt fiber layer without other layers or structures. For example, when the outer mesh layer is used to secure the basalt fiber layer, the core structure may be omitted.

In some manufacturing methods, the basalt fiber sorbent boom disclosed herein may be formed by cutting or forming the basalt fiber layer to circumferentially fit around individual sections of the core structure, or around subsequent layers of the basalt fiber layer. In some manufacturing methods, the basalt fiber sorbent boom disclosed herein may be formed by wrapping a continuous length of a basalt fiber layer around the core structure or around subsequent layers of the basalt fiber layer. When additional layers of the basalt fiber layer are used, each additional layer can be selected with a different form factor or fiber type to selectively capture different kinds of undesirable materials, such as undesirable materials having different viscosities and densities. By using various dimensions of the core layer, such as radius and length, in combination with various dimensions and numbers of layers of the basalt fiber layer, different sizes, shapes, and designs of the basalt fiber sorbent boom can be constructed and used in different applications, such as for remediating spills of different undesirable materials, as disclosed herein.

Furthermore, the size of the basalt fiber sorbent boom may be selected based on a concentration or amount of the undesirable materials, types of the undesirable materials, or a desired degree of removal of the undesirable materials, such as an amount of the undesirable material for each basalt fiber sorbent boom.

In some embodiments, the core structure may be changed according to whether the undesirable materials are on water or on land. For example, either a buoyant core or a non-buoyant core may be used as the core structure for the removal of spills of undesirable materials on land, according to the situation. The core structure may be composed of metals, ceramics, polymers, or combinations thereof, in different embodiments. A design of the core structure may adopt various forms, such as rods, tubes, chains, cables, segmented elements, non-segmented elements, or combinations thereof. For example, various types or arrangement of segmented elements of the core structure can be implemented based on a desired flexibility of the basalt fiber sorbent boom.

In some embodiments, the core structure may comprise a tube or a prism that is filled with a buoyant material, such as a ceramic foam or air in a sealed chamber. The tube or the prism may be used as the core structure for implementations on land and may be filled with different materials, such as for particular applications or undesirable materials.

In some embodiments, the basalt fiber sorbent boom may be used after removal from a hermetically sealed packaging, such as on surface water or on land. Such deployment of the basalt fiber sorbent boom may occur from a vessel on water, or from the ground, for example. As noted, the hermetically sealed packaging around the basalt fiber sorbent boom may ensure that the heat-treated state of the basalt fiber layer is maintained, as described above, for optimal remediation performance when used, such as after storage for a period of time. The hermetically sealed packaging can be made of a polymer material, such as described above, among other materials that may be recyclable, and can be securely discarded without release into the environment.

In some embodiments, the basalt fiber sorbent boom disclosed herein may be reused, such as after separation or isolation of the undesirable materials captured. Due to the high mechanical integrity of the basalt fibers, the basalt fiber sorbent boom can be subject to multiple recycling processes and reused, which can be economically desirable. The captured undesirable materials may be recovered from the basalt fiber layer using various methods, including mechanical methods or by washing with an organic solvent such as diethyl ether, dichloromethane (DCM), ethyl acetate, acetone, hexane, methanol, ethanol, or petroleum ether, among others, without degrading the structure of the basalt fiber layer, in particular embodiments.

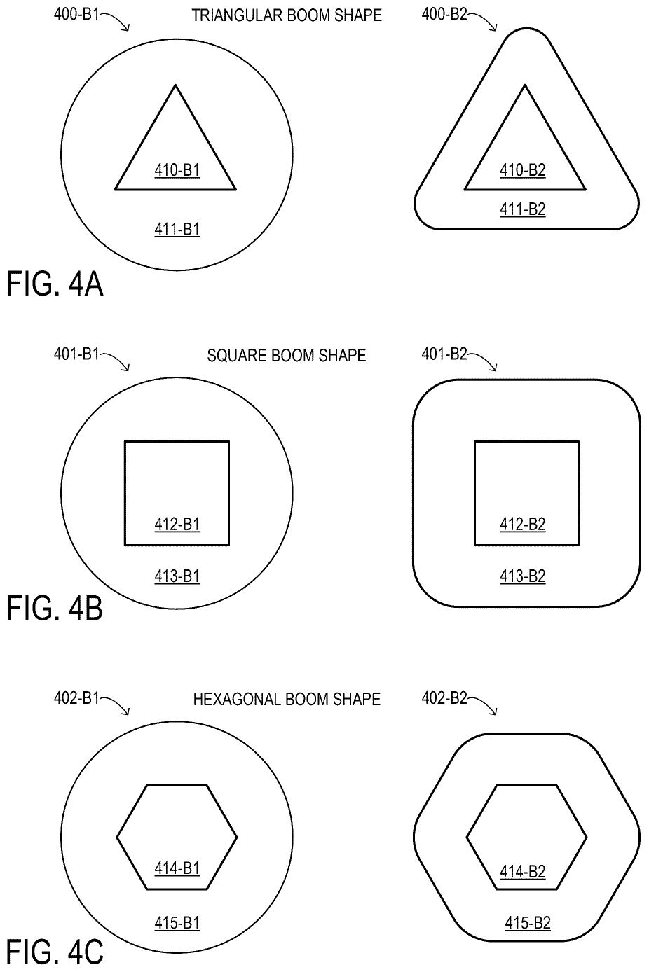

Referring now to the drawings, FIG. 1 is a depiction of a basalt fiber sorbent boom 100, in one exemplary embodiment. FIG. 1 is a schematic illustration and is not necessarily drawn to scale or perspective. As shown in FIG. 1, basalt fiber sorbent boom 100 is a general depiction, while certain elements can be added, removed, or modified in particular embodiments as will be described in further detail below. In particular, while a cylindrical geometry and shape are shown in FIG. 1 and in subsequent drawings for descriptive clarity, it will be understood that alternative shapes and geometries for basalt fiber sorbent boom 100 can be implemented in various embodiments (see also FIGS. 4A, 4B, 4C, and 4D).

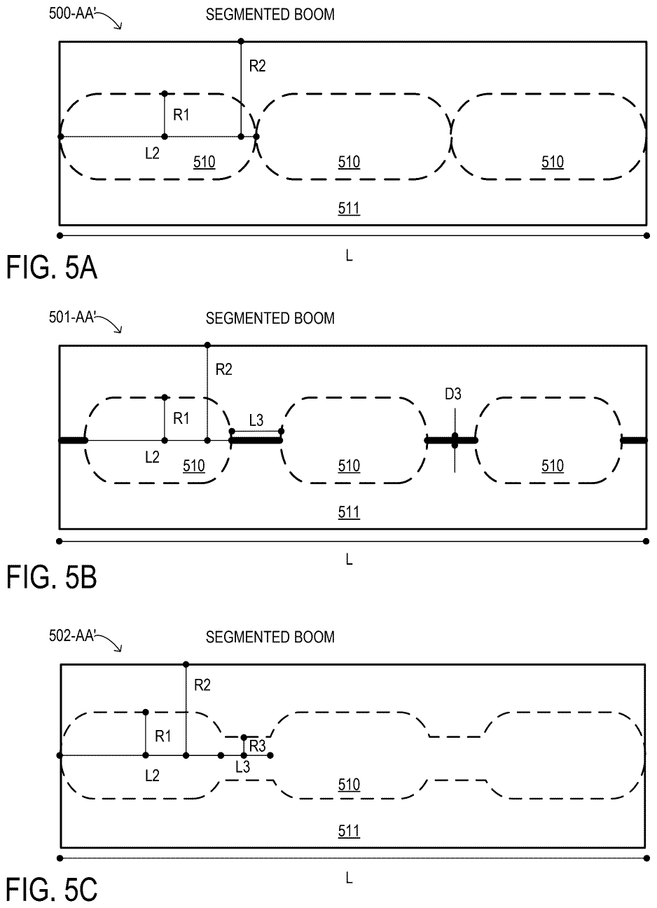

FIG. 1 depicts a perspective view of basalt fiber sorbent boom 100 having an arbitrary length L, with a core structure 102 in a cylindrical shape having a radius of R1. Surrounding buoyant core 102 is a basalt fiber layer 101 placed around buoyant core 102 in a cylindrical tube shape having an outer radius R2 and a tube thickness given by (R2-R1). Basalt fiber layer 101 may be wrapped around outer surface 104 of core structure 102 corresponding to radius R1, while basalt fiber layer 101 may have an external surface 106 corresponding to radius R2 that can form an outer surface of basalt fiber sorbent boom 100, in various embodiments. Furthermore, although basalt fiber layer 101 is shown as a unitary layer, basalt fiber layer 101 can comprise multiple sub-layers of basalt fiber material in various embodiments, as noted above. Also shown in FIG. 1 is a sectional line AA′ defining a plane bisecting basalt fiber sorbent boom 100 along a centerline, for which corresponding exemplary sectional views are shown in FIGS. 5A, 5B, and 5C. In FIG. 1, an arrow B indicates a plane view of an end section of basalt fiber sorbent boom 100, for which corresponding exemplary sectional end views are shown in FIGS. 4A, 4B, and 4C.

Furthermore, various parameters and structural features of basalt fiber sorbent boom 100 may be designed or selected for particular applications of remediating undesirable materials, such as for unwanted spills on land or on surface water, as explained above. In particular, radius R1 and radius R2 can be determined based on a desired size of basalt fiber sorbent boom 100, such as with respect to a capacity of absorption or retention of undesirable materials. Similarly, length L of basalt fiber sorbent boom 100 can be selected based on a desired size or dimension, such as for a given product type or variant, or in relation to radius R1 and radius R2. Still further, a packing density of basalt fiber layer 101 can be selected based on a desired absorption or retention capacity for undesirable material, weight, buoyancy, or other performance characteristic of basalt fiber sorbent boom 100. In this manner, basalt fiber sorbent boom 100 can be implemented with respect to a desired dimension, size, weight, capacity, or particular undesirable material, among other properties disclosed herein.

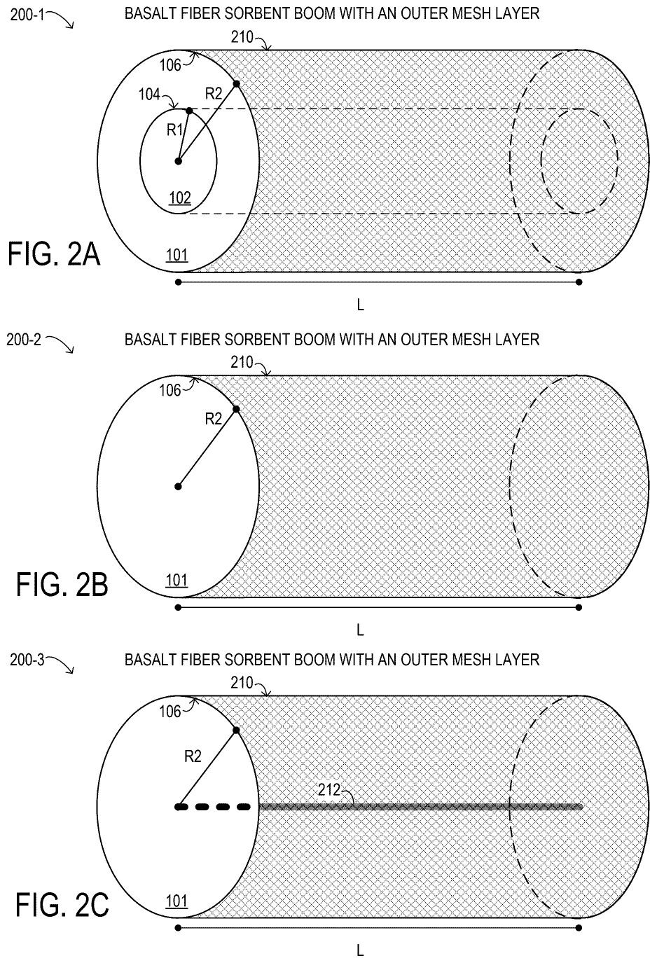

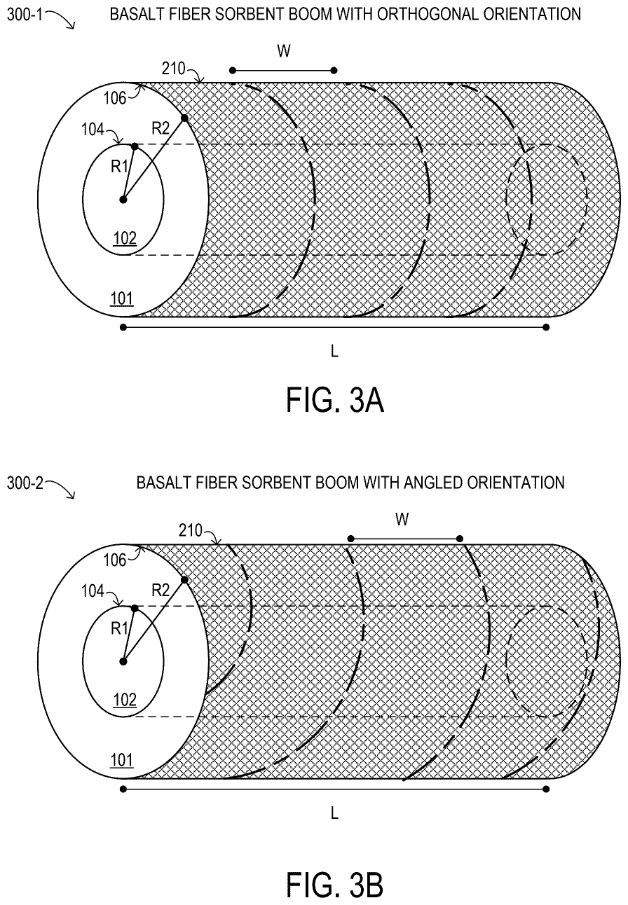

In particular methods of manufacture of basalt fiber sorbent boom 100, basalt fiber layer 101 may be wrapped or otherwise placed around outer surface 104 of core structure 102. In some embodiments, core structure 102 may be omitted (see also FIG. 2B) or may be formed from a singular solid element, such as a cable, a rod, a rope, a fiber strand or similar structure (see also FIG. 2C). In some embodiments, core structure 102 may be formed as a segmented structure, for example, to provide basalt fiber sorbent boom 100 with a desired degree of linear flexibility (see also FIGS. 5A, 5B, and 5C). In particular embodiments when basalt fiber layer 101 is provided as a continuous feedstock have a given width, basalt fiber layer 101 can be continuously wound in at least one layer and in a desired orientation, such as an orthogonal orientation or an angled orientation (see also FIGS. 3A and 3B). Although various different exemplary embodiments and implementations of basalt fiber sorbent boom 100 are shown and described below with respect to the subsequent drawings, it is noted that different features and elements can be combined or omitted in different ways that may not be explicitly depicted in the drawings, but are disclosed and described herein and are intended to be within the scope of the present disclosure. Thus any implementation shown and described herein may be combined with other implementations disclosed herein.

In some methods of operation, such as on surface water, core structure 102 can be buoyant sufficient to prevent basalt fiber sorbent boom 100 from sinking when placed in the surface water, such as in the presence of undesirable material that has spilled into the surface water. Accordingly, basalt fiber sorbent boom 100 can be removed from a hermetically sealed packaging prior to deployment in the surface water, such as from land or from a vessel on the surface water. After placement in the contaminated surface water for a period of time, basalt fiber sorbent boom 100 can then be collected along with the undesirable material captured therewith. Because basalt fiber sorbent boom 100 is substantially hydrophobic and does not absorb an appreciable amount of the surface water, the use of basalt fiber sorbent boom 100 can provide effective separation of the undesirable material from the surface water. The effective separation can be characterized at least in part by a relatively high mass efficiency due to the negligible amount of the surface water retained by basalt fiber sorbent boom 100. After removal from the surface water, basalt fiber sorbent boom 100 can be discarded along with the undesirable material in a suitable manner, such as in compliance with environmental regulations. As noted, in some embodiments, after removal from the surface water, basalt fiber sorbent boom 100 may be recycled, such as by separating or isolating the undesirable material from basalt fiber sorbent boom 100 and then restoring basalt fiber sorbent boom 100 to a substantially original condition, such as a suitable condition for reuse.

In some methods of operation, such as on dry land, basalt fiber sorbent boom 100 can be used in a substantially similar manner as on surface water, described above For use on dry land, in particular embodiments, core structure 102 can be selected for weight (e.g., instead of buoyancy) to provide sufficient anchoring or stability in placement. In some embodiments of use on land, core structure 102 can be omitted and can provide improved overall volume absorption capability to basalt fiber sorbent boom 100 that may increase economic performance, which can be desirable. In certain applications, a lack of buoyancy for use in mixed land and surface water applications can be desirable, such as for protecting or remediating a shoreline or in shallow water depths where at least one basalt fiber sorbent boom 100 may from a barrier from the ground to a surface of the water.

In various methods of operation, after the basalt fiber sorbent boom has retained a certain amount of the undesirable materials, the undesirable materials may be recovered by separating the undesirable materials from the basalt fiber. For example, mechanical separation may involve squeezing or wringing the basalt fibers and can recover as much as 98-99% of the undesirable materials. Various kinds of mechanical separation can be used, such as squeezing, pressing, spinning, or centrifuging, among others. As noted, chemical separation can be performed to collect the undesirable material using a solvent. In some cases, when a large portion of the undesirable materials are separated from the basalt fibers in the sorbent boom and are recovered, the basalt fiber sorbent boom can be reused without further remediation to collect and retain additional undesirable materials. When mechanical separation is used, the recovered undesirable materials may themselves be used or reused, which can be economically desirable.

Whether the undesirable materials are mostly separated from, partially separated from, or mostly remain with the basalt fibers, the basalt fibers can be heated to vaporize any remaining undesirable materials, in particular embodiments. In some embodiments, the mechanical separation can be performed first, followed by heating to vaporize the remaining undesirable materials. Such a vaporization can be performed at different temperatures and various durations, such as depending on the chemical composition of the undesirable materials, In particular embodiments, the heating to vaporize the undesirable materials may be done at a low enough temperature such that the basalt fibers are maintained or can be reused in the sorbent boom. In different embodiments, the heating to vaporize the undesirable materials may be done at a high enough temperature that the basalt fibers melt or coalesce together to form particles or basalt rock. Furthermore, the heating to vaporize the undesirable materials may be done in a controlled environment to capture any exhaust gases or vaporized chemicals. As a result of the foregoing, the use of the basalt fiber sorbent boom can facilitate environmentally friendly disposal after use, or even reuse, which are desirable.

FIGS. 2A, 2B, and 2C are respective depictions of a basalt fiber sorbent boom 200 with an outer mesh layer 210, in three exemplary embodiment. Specifically, FIG. 2A depicts basalt fiber sorbent boom 200-1 with outer mesh layer 210 that is substantially similarly depicted as basalt fiber sorbent boom 100 in FIG. 1; FIG. 2B depicts basalt fiber sorbent boom 200-2 with outer mesh layer 210 that omits core structure 102 and comprises basalt fiber layer 101 throughout; and FIG. 2C depicts basalt fiber sorbent boom 200-3 with outer mesh layer 210 that has a linear core 212 that may represent a rod, a cable, a wire, a rope, or similar linear structure.

FIGS. 2A, 2B, and 2C are schematic illustrations and are not necessarily drawn to scale or perspective. In FIGS. 2A, 2B, and 2C, basalt fiber sorbent boom 200 is shown having outer mesh layer 210 that may substantially and uniformly surround external surface 106 corresponding to R2 of basalt fiber layer 101 of basalt fiber sorbent boom 200. Outer mesh layer 210 may accordingly be affixed to basalt fiber layer 101. Outer mesh layer 210 may mechanically retain basalt fiber layer 101, such as by providing additional stiffness or by protecting basalt fiber layer 101 from detaching or being removed by external forces, as noted above. Outer mesh layer 210 can be a relatively coarse and open mesh that permits fluids to penetrate basalt fiber sorbent boom 200. Accordingly, outer mesh layer 210 can be made of a rigid material that provides structural support and a desired degree of stiffness to basalt fiber sorbent boom 200. In particular embodiments, outer mesh layer 210 does not include polymers or plastic material. In some embodiments, outer mesh layer 210 can also be made from basalt fibers or basal rod that is joined to form a mesh. The mesh in outer mesh layer 210 can be a regular or an irregular mesh, such as a polygonal mesh or a rectangular mesh having various dimensions, such as for the rod thickness or for a size or shape of a cell forming the mesh. Furthermore, outer mesh layer 210 can be affixed, or can retain, basalt fiber layer 101 using fasteners or fastening means, such as wires, clips, bands, or other suitable means. In some embodiments, outer mesh layer 210 can extend to end portions of basalt fiber sorbent boom 200, such as to enclose or encapsulate basalt fiber layer 101, for example.

Additionally, in some embodiments, basalt fiber sorbent boom 100, 200 or other variants may be equipped with means for linear interconnection with each other, also referred to as ‘daisy chaining’, to enable extension of length along a primary axis. For example, basalt fiber sorbent boom 100, 200 may include a hook at one end and an eye (e.g., a ring) at another end as an example of the means for linear interconnection. In this manner, a hook of one basalt fiber sorbent boom 100, 200 can be mechanically coupled to an eye of a subsequent basalt fiber sorbent boom 100, 200 to effectively form a longer boom. It is noted that different types or styles or configurations of basalt fiber sorbent boom 100, 200 can be linked in this manner, as desired.

FIG. 3A is a depiction of a basalt fiber sorbent boom 300-1 with orthogonal orientation, in one exemplary embodiment. Specifically, basalt fiber sorbent boom 300-1 is shown with an outer mesh layer 210 and comprises basalt fiber layer 101 wrapped in an orthogonal orientation. FIG. 3A is a schematic illustration and is not necessarily drawn to scale or perspective. In FIG. 3A, basalt fiber sorbent boom 300-1 is substantially similar to basalt fiber sorbent boom 200 shown in FIG. 2. In particular, basalt fiber sorbent boom 300-1 depicts a wrapped implementation of basalt fiber layer 101 that can be formed from continuous feedstock of basalt fiber material having a width W as indicated in FIG. 3A. As a result, multiple instances of the basalt fiber material having width W may be combined to arrive at length L of basalt fiber sorbent boom 300-1. Accordingly, visible in basalt fiber sorbent boom 300-1 are sections of basalt fiber layer 101 having width W that have been wrapped at an angle of about 90 degrees and are depicted in dashed lines.

FIG. 3B is a depiction of a basalt fiber sorbent boom 300-2 with angled orientation, in one exemplary embodiment. Specifically, basalt fiber sorbent boom 300-2 is shown with an outer mesh layer 210 and comprises basalt fiber layer 101 wrapped in an angled orientation. FIG. 3B is a schematic illustration and is not necessarily drawn to scale or perspective. In FIG. 3B, basalt fiber sorbent boom 300-2 is substantially similar to basalt fiber sorbent boom 200 shown in FIG. 2. In particular, basalt fiber sorbent boom 300-2 depicts a wrapped implementation of basalt fiber layer 101 that can be formed from continuous feedstock of basalt fiber material having a width W as indicated in FIG. 3B. As a result, the continuous feedstock may be spirally wrapped at an angle to arrive at length L of basalt fiber sorbent boom 300-2. Accordingly, visible in basalt fiber sorbent boom 300-2 are spirally wrapped portions of basalt fiber layer 101 having width W that have been wrapped at an angle less than 90 degrees, such as about 45 degrees, and are depicted in dashed lines. It is noted that various angles of wrapping can be used in different embodiments and the exemplary depiction in FIG. 3B is presented for descriptive purposes, rather than to show any one specific angle of wrapping. Also visible in FIG. 3B are various end portions of basalt fiber layer 101 that have been trimmed or cut to shape to form basalt fiber sorbent boom 300-2 in a cylindrical shape, for example.

FIG. 4A shows depictions of a triangular boom shape 400, in two exemplary embodiments. Specifically, FIG. 4A depicts a triangular boom shape 400-B1 and 400-B2 as sectional end views corresponding to arrow B in FIG. 1. FIG. 4A is a schematic illustration and is not necessarily drawn to scale or perspective. Triangular boom shape 400-B1 shows a core structure 410-B1 formed in a triangular shape, such as a triangular prism, surrounded by a basalt fiber layer 411-B1 that retains an outer cylindrical shape. Triangular boom shape 400-B2 shows a core structure 410-B2 formed in the triangular shape, such as a triangular prism, surrounded by a basalt fiber layer 411-B2 that substantially corresponds to the triangular shape and results in an outer triangular prism shape.

FIG. 4B shows depictions of a square boom shape 401, in two exemplary embodiments. Specifically, FIG. 4B depicts a square boom shape 401-B1 and 401-B2 as sectional end views corresponding to arrow B in FIG. 1. FIG. 4B is a schematic illustration and is not necessarily drawn to scale or perspective. Square boom shape 401-B1 shows a core structure 412-B1 formed in a square shape, such as a square prism, surrounded by a basalt fiber layer 413-B1 that retains an outer cylindrical shape. Square boom shape 401-B2 shows a core structure 412-B2 formed in the square shape, such as a square prism, surrounded by a basalt fiber layer 413-B2 that substantially corresponds to the square shape and results in an outer square prism shape.

FIG. 4C shows depictions of a hexagonal boom shape 402, in two exemplary embodiments. Specifically, FIG. 4C depicts a hexagonal boom shape 402-B1 and 402-B2 as sectional end views corresponding to arrow B in FIG. 1. FIG. 4C is a schematic illustration and is not necessarily drawn to scale or perspective. Hexagonal boom shape 402-B1 shows a core structure 414-B1 formed in a hexagonal shape, such as a hexagonal prism, surrounded by a basalt fiber layer 415-B1 that retains an outer cylindrical shape. Hexagonal boom shape 402-B2 shows a core structure 414-B2 formed in the hexagonal shape, such as a hexagonal prism, surrounded by a basalt fiber layer 415-B2 that substantially corresponds to the hexagonal shape and results in an outer hexagonal prism shape.

Although triangular, square, and hexagonal shapes are shown in FIGS. 4A, 4B, and 4C, respectively, for descriptive purposes, it is noted that various other regular or irregular shapes can be used, including various other polygons, ellipses, parallelograms, trapezoids, diamonds, crosses, chevrons, semicircles, teardrops, or right triangles, among others. Furthermore, various dimensions, sizes, or relative sizes of elements depicted in FIGS. 4A, 4B, and 4C may be varied in different embodiments and implementations.

FIG. 5A is a depiction of a segmented boom 500-AA′, in one exemplary embodiment, representing a basalt fiber sorbent boom, as disclosed herein. FIG. 5A is a schematic illustration and is not necessarily drawn to scale or perspective. FIG. 5A is depicted as an exemplary sectional view corresponding to sectional line AA′ in FIG. 1 defining a plane bisecting basalt fiber sorbent boom 100 along a centerline. Specifically, segmented boom 500-AA′ depicts a core structure 510 that is segmented into subsections having respective widths L2 that are smaller than overall length L. The subsections of width L2 (or simply “subsections L2”) in segmented boom 500-AA′ are tapered at end sections from radius R2 where adjacent subsections L2 meet. In this manner, segmented boom 500-AA′ may be imparted an increased linear flexibility that specifically depends upon structural parameters R1, L2, L and R2, in various embodiments. As shown in segmented boom 500-AA′, an outer dimension or diameter R2 is constant along length L. However, in other embodiments, the outer dimension or diameter R2 may also vary along length L to impart flexibility, for example. In FIG. 5A, a basalt fiber layer 511 surrounds or encapsulates core structure 510, and may have an increased volume due to the tapering of core structure 510, which can also be desirable.

FIG. 5B is a depiction of a segmented boom segmented boom 501-AA′, in one exemplary embodiment, representing a basalt fiber sorbent boom, as disclosed herein. FIG. 5B is a schematic illustration and is not necessarily drawn to scale or perspective. FIG. 5B is depicted as an exemplary sectional view corresponding to sectional line AA′ in FIG. 1 defining a plane bisecting basalt fiber sorbent boom 100 along a centerline. Specifically, segmented boom 501-AA′ depicts a core structure 510 that is segmented into subsections having respective widths L2 that are smaller than overall length L. The subsections of width L2 (or simply “subsections L2”) in segmented boom 501-AA′ are tapered at end sections from radius R2. In between subsections L2 in segmented boom 501-AA′, a linear core of length L3 (or simply “linear core L3”) can connect subsections L2 with each other, and has a diameter D3. In segmented boom 501-AA′, linear cores L3 may represent a rod, a cable, a wire, a rope, or similar linear structure, that can correspond to linear core 212 (see FIG. 2C). In this manner, segmented boom 501-AA′ may be imparted an increased linear flexibility that specifically depends upon structural parameters R1, L2, L3, L and R2, in various embodiments. As shown in segmented boom 501-AA′, an outer dimension or diameter R2 is constant along length L. However, in other embodiments, the outer dimension or diameter R2 may also vary along length L to impart flexibility, for example. In FIG. 5B, a basalt fiber layer 511 surrounds or encapsulates core structure 510 and linear cores L3, and may have an increased volume due to the tapering of core structure 510 and linear cores L3, which can also be desirable.

FIG. 5C is a depiction of a segmented boom 502-AA′, in one exemplary embodiment, representing a basalt fiber sorbent boom, as disclosed herein. FIG. 5C is a schematic illustration and is not necessarily drawn to scale or perspective. FIG. 5C is depicted as an exemplary sectional view corresponding to sectional line AA′ in FIG. 1 defining a plane bisecting basalt fiber sorbent boom 100 along a centerline. Specifically, segmented boom 502-AA′ depicts a core structure 510 that is segmented into subsections having respective widths L2 that are smaller than overall length L. The subsections of width L2 (or simply “subsections L2”) in segmented boom 502-AA′ are tapered at end sections from radius R2. In between subsections L2 in segmented boom 502-AA′, subsections of width L3 (or simply “subsections L3”) can connect subsections L2 with each other, and has a radius R3. In segmented boom 502-AA′, subsections L3 provide intermittent narrowing of core structure 510 that are weaker areas long length L. In this manner, segmented boom 502-AA′ may be imparted an increased linear flexibility that specifically depends upon structural parameters R1, L2, R3, L and R2, in various embodiments. As shown in segmented boom 502-AA′, an outer dimension or diameter R2 is constant along length L. However, in other embodiments, the outer dimension or diameter R2 may also vary along length L to impart flexibility, for example. In FIG. 5C, a basalt fiber layer 511 surrounds or encapsulates core structure 510, and may have an increased volume due to the tapering of core structure 510 at subsections L3, which can also be desirable.

Although no distinction has been made in the above description regarding variations in composition or structure of basalt fiber sorbent boom 300, core structure 510 may vary along length L in particular embodiments. For example, in some embodiments, a buoyancy of core structure 510 may be increased at a center portion of basalt fiber sorbent boom 300 and may be decreased at one or both end portions of basalt fiber sorbent boom 300, which can result in the end portions sinking deeper into water when basalt fiber sorbent boom 300 is used on surface water. In some embodiments, the center portion may have decreased buoyancy while one or both end portions have increased buoyancy, which can result in the center portion sinking deeper into water when basalt fiber sorbent boom 300 is used on surface water. In various other embodiments, the buoyancy of basalt fiber sorbent boom 300, or another property, may be varied along length L for a particular application or use case, such as to optimize performance or durability, among other potential benefits.

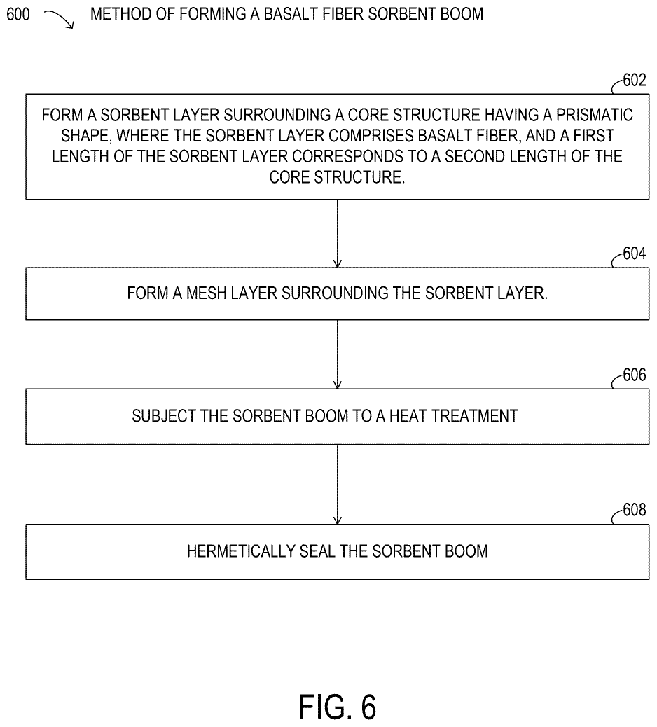

Referring now to FIG. 6, a flow chart of selected elements of an embodiment of a method 600 of forming a basalt fiber sorbent boom, as described herein, is depicted. Method 600 may depict a method of manufacture of basalt fiber sorbent boom 100, as disclosed herein. It is noted that certain operations described in method 600 may be optional or may be rearranged in different embodiments.

Method 600 may begin at step 602 by forming a sorbent layer surrounding a core structure having a prismatic shape, where the sorbent layer comprises basalt fiber, and a first length of the sorbent layer corresponds to a second length of the core structure. At step 604, a mesh layer surrounding the sorbent layer is formed. At step 606, the sorbent boom is subjected to a heat treatment. In some embodiments, the sorbent boom may be subjected to a chemical treatment, such as with an acid or a base, in step 606, or instead of step 606. At step 608, the sorbent boom is hermetically sealed.

The above disclosed subject matter is to be considered illustrative, and not restrictive, and are intended to cover all such modifications, enhancements, and other embodiments which fall within the true spirit and scope of the present disclosure.

What is claimed is:

1. A method of manufacture comprising:
forming a sorbent layer surrounding a core structure having a prismatic shape to produce a sorbent boom, wherein the sorbent layer comprises basalt fiber, and wherein a first length of the sorbent layer corresponds to a second length of the core structure.

2. The method of claim 1, wherein the sorbent layer consists of basalt fiber.

3. The method of claim 1, wherein the prismatic shape is selected from at least one of: a cylinder, a polygonal prism, or an irregular prism.

4. The method of claim 1, wherein the core structure is a solid structure.

5. The method of claim 1, wherein forming the sorbent layer further comprises:
wrapping the sorbent layer around the core structure, wherein the sorbent layer has a first width selected from at least one of: a roving, a wound yarn, a mat, or a felt.

6. The method of claim 5, wherein the core structure is provided as a continuous material, and wherein wrapping the sorbent layer around the core structure further comprises:
continuously winding the sorbent layer around the core structure.

7. The method of claim 6, wherein continuously winding the sorbent layer around the core structure further comprises:
continuously winding the sorbent layer at an angle of winding.

8. The method of claim 1, further comprising:
forming a mesh layer surrounding the sorbent layer.

9. The method of claim 1, further comprising:
forming the core structure as a continuous structure.

10. The method of claim 1, further comprising:
forming the core structure as a segmented structure that provides flexibility along the second length.

11. The method of claim 10, wherein forming the core structure as the segmented structure further comprises:
reducing a cross-sectional area of the core structure.

12. The method of claim 1, wherein forming the sorbent layer further comprises:
selecting the sorbent layer based on a volume density of the basalt fiber in the sorbent layer corresponding to an absorption capacity of the sorbent boom for undesirable material.

13. The method of claim 12, wherein the absorption capacity of the sorbent boom for the undesirable material is determined at least in part based on a viscosity of the undesirable material at ambient temperature.

14. The method of claim 1, wherein forming the sorbent layer further comprises:
forming the sorbent layer by forming multiple sorbent sub-layers comprising basalt fiber.

15. The method of claim 1, further comprising:
subjecting the sorbent boom to a treatment selected from at least one of a heat treatment or a chemical treatment.

16. The method of claim 15, wherein subjecting the sorbent boom to the heat treatment further comprises:
subjecting the sorbent boom to the heat treatment in an underpressure environment; and
wherein subjecting the sorbent boom to the chemical treatment further comprises:
subjecting the sorbent boom to an acid or a base.

17. The method of claim 15, further comprising:
subsequent to subjecting the sorbent boom to the treatment, hermetically sealing the sorbent boom.

18. A method of manufacture comprising:
forming a sorbent layer around a core structure to produce a sorbent boom, wherein the sorbent layer comprises basalt fiber; and
subjecting the sorbent boom to a treatment selected from at least one of a heat treatment or a chemical treatment.

19. The method of claim 18, further comprising:
hermetically sealing the sorbent boom.

20. A method of manufacture comprising:
forming a sorbent layer around a core structure to produce a sorbent boom, wherein the sorbent layer comprises basalt fiber;
subjecting the sorbent boom to a treatment selected from at least one of a heat treatment or a chemical treatment; and
hermetically sealing the sorbent boom,
wherein a volume density of the basalt fiber is determined based on an absorption capacity of the basalt fiber for undesirable material, wherein the absorption capacity is determined at least in part based on a viscosity of the undesirable material at ambient temperature.
